(19) United States
(12) Patent Application Publication
(10) Pub. No.: US 2019/0187515 A1
(43) Pub. Date: Jun. 20, 2019

(54) METHOD FOR PRODUCING DISPLAY PANEL

(71) Applicant: Sharp Kabushiki Kaisha, Sakai City (JP)

(72) Inventors: Masayuki OHASHI, Sakai City (JP); Jin NAKAMURA, Sakai City (JP); Nobuhisa NAKAJIMA, Sakai City (JP)

(21) Appl. No.: 16/199,299

(22) Filed: Nov. 26, 2018

(30) Foreign Application Priority Data
Dec. 19, 2017 (JP) 2017-242982

(51) Int. Cl. G02F 1/1335; G02F 1/1333

(52) U.S. Cl. CPC G02F 1/133528; G02F 1/133351

(57) ABSTRACT

According to the present invention, a display panel having a narrow frame and having an irregular shape is produced by a fewer number of steps, and the end faces of the polarizing plates are made flush with the end face of the glass substrate. Rectangular polarizing plates (51, 52) are bonded to a separate glass substrate (2) including a display region (21) with a cutout (31). The contour (41) of the separate glass substrate (2) and the contours (61) of the polarizing plates (51, 52) are simultaneously cut with use of an end mill or a laser.

This Nonprovisional application claims priority under 35 U.S.C. § 119 on Patent Application No. 2017-242982 filed in Japan on Dec. 19, 2017, the entire contents of which is hereby incorporated by reference.

### TECHNICAL FIELD

The present invention relates to a method for producing a display panel.

### BACKGROUND ART

A method for producing a display panel includes many steps. Various techniques have been conventionally proposed for reducing the number of steps included in the method for producing a display panel.

Patent Document 1 discloses a method for producing a liquid crystal panel, characterized in that a display panel and two electrode substrate members, which include a plurality of electrode substrates preferably made of plastic, are bonded so as to face each other, polarizing plates are bonded to corresponding back surfaces of the electrode substrate members, and thereafter, an end portion of one of the electrode substrate members is cut together with the polarizing plates to provide a terminal area at a time.

Patent Document 2 discloses a method for producing a liquid crystal device, characterized by including the step of bonding an optical film to an outer surface of at least one of a first base substrate and a second base substrate before a large-sized panel is divided into separate panels.

Patent Document 3 discloses a method for producing a display device, including the steps of: bonding a first base substrate and a second base substrate to each other; bonding a first polarizing plate to the first base substrate; bonding a second polarizing plate to the second base substrate; and subjecting the first polarizing plate, the first base substrate, the second base substrate, and the second polarizing plate to dicing by batch.

### CITATION LIST

### Patent Literatures

### [Patent Literature 1]

Japanese Patent Application Publication Tokukai No. 2002-277860

### [Patent Literature 2]

Japanese Patent Application Publication Tokukai No. 2007-248594

### [Patent Literature 3]

Japanese Patent Application Publication Tokukai No. 2016-90855

### SUMMARY OF INVENTION

### Technical Problem

In recent years, a panel incorporated into a smart phone and a wearable device has had a narrower frame, and there has been a growing demand for a display panel having not only a narrower frame but also an irregular shape (circular shape, cutout, cut at corners, etc.). Applying the techniques disclosed in Patent Documents 1 to 3 to a method for producing a display panel including a glass substrate and having a narrow frame and an irregular shape gives rise to the following problems.

The technique disclosed in Patent Document 1 is applied to processing of an electrode substrate made of plastic, but is not applied to processing of a glass substrate.

The technique disclosed in Patent Document 2 is applicable to rectangular shape splitting of a glass substrate, but is not applicable to irregular shape processing of a glass substrate. The technique disclosed in Patent Document 3 requires performing the processing of the polarizing plates and the processing of a glass substrate at different times. Accordingly, it is necessary for a glass substrate maker and a polarizing plate maker to perform irregular shape processing of a glass substrate and irregular shape processing of the polarizing plates at different times. This increases the number of steps in the production method.

Furthermore, the techniques disclosed in Patent Documents 1 and 3 fail to make the end faces of the polarizing plates and the end faces of the glass substrate flush with each other.

The present invention has been attained to solve the above problems, and it is an object of the present invention to produce a display panel having a narrow frame and having an irregular shape by a fewer number of steps and to make the end faces of the polarizing plates flush with the end face of the glass substrate.

### Solution to Problem

A method for producing a display panel in accordance with an aspect of the present invention includes the steps of: bonding a polarizing plate having a rectangular shape to a separate glass substrate, the separate glass substrate having a rectangular shape and including a display region having at least one cutout; and simultaneously cutting a contour of the separate glass substrate and a contour of the polarizing plate with use of an end mill or a laser.

### Advantageous Effects of Invention

An aspect of the present invention yields the effect of processing a display panel having a narrow frame and having an irregular shape so that the end faces of the polarizing plates are made flush with the end face of the glass substrate and producing such a display panel having a narrow frame and having an irregular shape by a fewer number of steps.

### BRIEF DESCRIPTION OF DRAWINGS

FIG. 1 is a view illustrating a large-sized glass substrate including a plurality of display regions with respective ones of cutouts, in accordance with an embodiment of the present invention.

FIG. 2 is a view illustrating a separate glass substrate including one display region with a cutout, in accordance with an embodiment of the present invention.

FIG. 3 is a view illustrating polarizing plates in accordance with an embodiment of the present invention.

FIG. 4 is a view illustrating the separate glass substrate with the polarizing plates bonded thereto, in accordance with an embodiment of the present invention.

FIG. 5 is a view illustrating a display panel obtained by irregular shape processing, in accordance with an embodiment of the present invention.

FIG. 6 is an explanatory view illustrating other example method for producing a display panel in accordance with an embodiment of the present invention.

FIG. 7 is an explanatory view illustrating the advantages of the display panel produced by the production method in accordance with an embodiment of the present invention.

### DESCRIPTION OF EMBODIMENTS

(Large-Sized Glass Substrate 1)

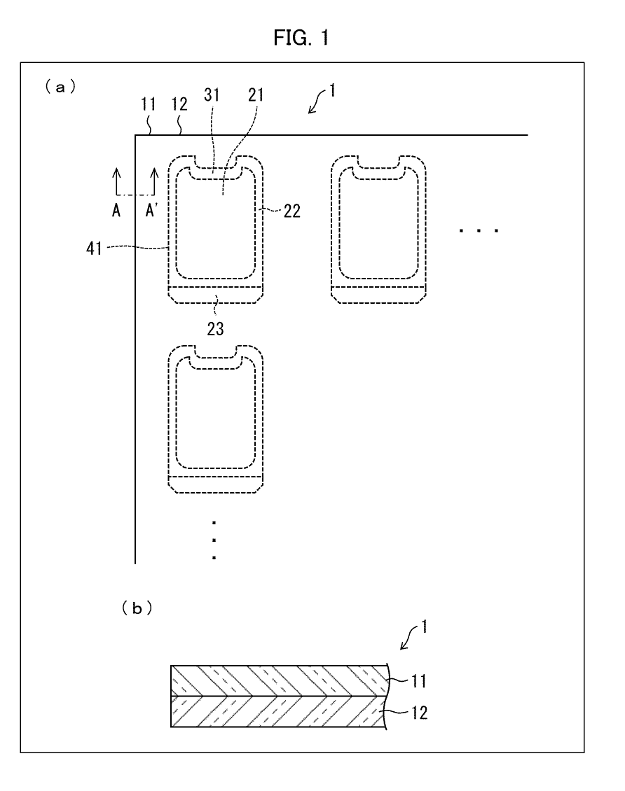

FIG. 1 is a view illustrating a large-sized glass substrate 1 including a plurality of display regions 21 with respective ones of cutouts 31, in accordance with an embodiment of the present invention. (a) of FIG. 1 illustrates the large-sized glass substrate 1 when viewed from above, and (b) of FIG. 1 illustrates a cross section of the large-sized glass substrate 1 when viewed along a line A-A′ in (a) of FIG. 1.

In carrying out a method for producing a display panel, a display panel maker first prepares a large-sized glass substrate 1 like the one illustrated in FIG. 1. The large-sized glass substrate 1 includes a color filter (CF) substrate 11 and a thin film transistor (TFT) substrate 12. The CF substrate 11 and the TFT substrate 12 are glass substrates. As illustrated in (b) of FIG. 1, the large-sized glass substrate 1 has a laminated structure of the CF substrate 11 and the TFT substrate 12.

The large-sized glass substrate 1 includes a plurality of display regions 21 each having an irregular shape. The irregular shape means a non-rectangular shape. The display regions 21 each have cutouts 31. Each of the display regions 21 has at least one cutout and may alternatively have other cutout which is different from the cutouts 31. The display regions 21 are surrounded by respective ones of frame regions 22. A connection region 23 is located on a lower side of the frame region 22 in a paper sheet of FIG. 1. The connection region 23 is a region where a driver for driving the display region 21 is provided. The connection region 23 is also a region where a wiring to be connected to one end of a flexible printed circuit board (FPC) is formed. The FPC is a substrate for connecting the display panel to an external device. A place where the driver is mounted is not limited to the connection region 23. The connection region 23 can alternatively be mounted on the FPC or on an external substrate.

On a surface of the CF substrate 11 which surface faces the TFT substrate 12, various resin thin films are formed. Examples of the resin thin films include black matrix, a red color filter, a green color filter, and a blue color filter. These resin thin films are formed on the surface of the CF substrate in an area corresponding to the display region 21.

On a surface of the TFT substrate 12 which surface faces the CF substrate 11, TFTs and a wiring are formed. The TFTs are formed on the surface of the CF substrate 11 in an area corresponding to the display region 21. The wiring is formed on the surface of the CF substrate 11 in areas corresponding to the display region 21, the frame region 22, and the connection region 23.

Liquid crystal is injected into a space, provided between the CF substrate 11 and the TFT substrate 12, corresponding to the display region 21. Thus, the display region 21 is equivalent to a display region of a liquid crystal display section. The display region 21, however, is not limited to such a display region, and can alternatively be a display region of an organic EL display section or a display region of other display section.

The rim of the frame region 22 coincides with contours 41 of the CF substrate 11 and the TFT substrate 12 in the display panel. As described in detail later, the contour 41 of the CF substrate 11 and the contour 41 of the TFT substrate 12 are simultaneously cut.

(Rectangular Shape Division of Large-Sized Glass Substrate 1)

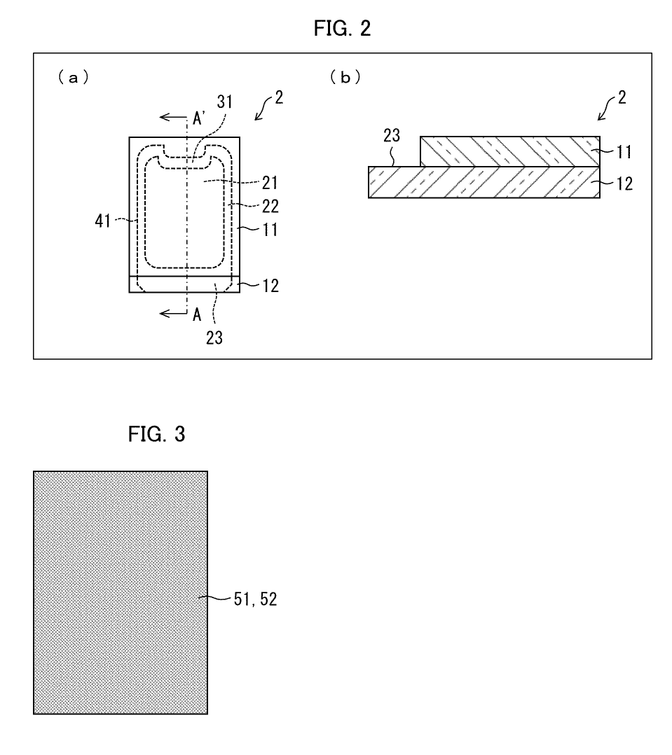

FIG. 2 is a view illustrating a separate glass substrate 2 including one display region 21 with a cutout 31, in accordance with an embodiment of the present invention. (a) of FIG. 2 illustrates the separate glass substrate 2 when viewed from above, and (b) of FIG. 2 illustrates a cross section of the separate glass substrate 2 when viewed along a line A-A′ in (a) of FIG. 2. A display panel maker divides the large-sized glass substrate 1 illustrated in FIG. 1 into a plurality of separate glass substrates 2 in cell units as illustrated in FIG. 2. The separate glass substrate 2 in cell unit means a separate glass substrate 2 including one display region 21 with a cutout 31. In other words, the separate glass substrate 2 includes one display region 21, one frame region 22, and one connection region 23.

The separate glass substrate 2 illustrated in FIG. 2 is rectangular in shape. At this stage, a display panel maker cuts the separate glass substrate 2 at a part corresponding to the connection region 23. Accordingly, in the connection region 23 of the separate glass substrate 2, the TFT substrate 12 is present, but the CF substrate 11 is not present (as illustrated in (b) of FIG. 2). Such exposure of the connection region 23 allows the driver to be provided in the connection region 23 and allows for connection to the FPC.

At this stage, the display panel maker does not perform irregular shape processing on the separate glass substrate 2. In other words, in the separate glass substrate 2, the contour 41 of the CF substrate 11 and the contour 41 of the TFT substrate 12 are not cut.

(Polarizing Plates 51 and 52)

FIG. 3 is a view illustrating polarizing plates 51 and 52 in accordance with an embodiment of the present invention. The polarizing plates 51 and 52 are prepared by a polarizing plate maker. Each of the polarizing plates 51 and 52 illustrated in FIG. 3 has a cell unit size that accommodates the size of the separate glass substrate 2 into which the large-sized glass substrate 1 is divided in cell unit as illustrated in FIG. 2. The maker of the polarizing plates 51 and 52 first produces one or more large-sized polarizing plates and divides them into separate polarizing plates in cell units. Consequently, the polarizing plates 51 and 52 of a size illustrated in FIG. 3 are produced. In an example case illustrated in FIG. 3, the polarizing plates 51 and 52 are larger in size than the display region 21 illustrated in FIG. 2. Before bonded to the large-sized glass substrate 1, the polarizing plates 51 and 52 are rectangular in shape. In other words, the maker of the polarizing plates 51 and 52 does not perform irregular shape processing on the polarizing plates 51 and 52 in cell units.

The maker of the polarizing plates 51 and 52 delivers, to the display panel maker, the polarizing plates 51 and 52 in cell units illustrated in FIG. 3. Alternatively, the maker of the polarizing plates 51 and 52 can deliver one or more large-sized polarizing plates to the display panel maker, and the display panel maker can divide the one or more large-sized polarizing plates thus delivered into the polarizing plates 51 and 52 in cell units.

(Bonding of Polarizing Plates 51 and 52)

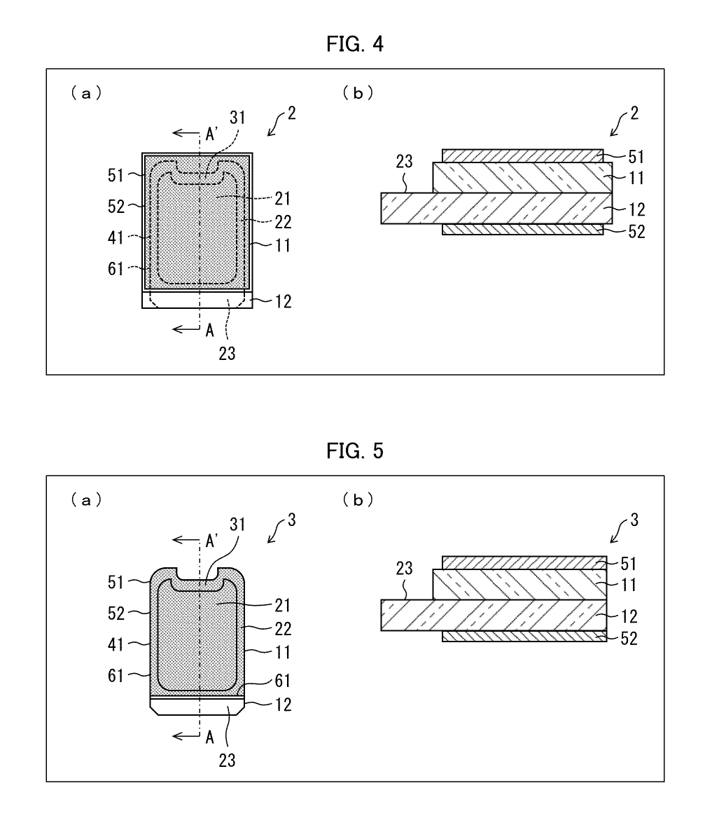

FIG. 4 is a view illustrating the separate glass substrate 2 with the polarizing plates 51 and 52 bonded thereto, in accordance with an embodiment of the present invention. (a) of FIG. 4 illustrates a top surface of the separate glass substrate 2 with the polarizing plates 51 and 52 bonded thereto, and (b) of FIG. 4 illustrates a cross section of the separate glass substrate 2 when viewed along a line A-A′ in (a) of FIG. 4. The display panel maker bonds the rectangular polarizing plate 51 illustrated in FIG. 3 to the surface of the rectangular separate glass substrate 2 illustrated in FIG. 2 on the CF substrate 11 side. The polarizing plate 51 is disposed on the surface of the CF substrate 11 in such a manner that the display region 21 is overlaid in whole with the polarizing plate 51. The display panel maker further bonds the rectangular polarizing plate 52 illustrated in FIG. 3 to the surface of the TFT substrate 12 in the rectangular separate glass substrate 2 illustrated in FIG. 2. The polarizing plate 52 is disposed on the surface of the TFT substrate 12 in such a manner that the display region 21 is overlaid in whole with the polarizing plate 52.

Through the bonding of the polarizing plates 51 and 52, the outlines 61 of the polarizing plates 51 and 52 are determined with respect to the separate glass substrate 2. In the separate glass substrate 2, the contour 61 coincides with the contours 41. At this stage, the separate glass substrate 2 is not subjected to irregular shape processing.

(Simultaneous Irregular Shape Processing)

FIG. 5 is a view illustrating the display panel 3 obtained by irregular shape processing, in accordance with an embodiment of the present invention. (a) of FIG. 5 illustrates the display panel 3 when viewed from above, and (b) of FIG. 5 illustrates a cross section of the display panel 3 when viewed along a line A-A′ in (a) of FIG. 5.

The display panel maker performs irregular shape processing simultaneously on the constituent components of the separate glass substrate 2 illustrated in FIG. 4, i.e., the CF substrate 11, the TFT substrate 12, the polarizing plate 51, and the polarizing plate 52. Specifically, contours 41 of the CF substrate 11 and the TFT substrate 12 and contours 61 of the polarizing plates 51 and 52 are simultaneously cut with use of an end mill or a laser. This produces a display panel 3, as illustrated in FIG. 5, having a narrow frame and having an irregular shape.

Thereafter, to the irregularly-shaped display panel 3, components such as a backlight module, a driver IC, and a flexible printed circuit board are mounted sequentially. This produces a display panel 3 in finished form. Note that a light guide plate contained in the backlight module has an irregular shape similarly to the irregular shape of the display region 21 and other components. However, the light guide plate, which is produced by injection molding with a plastic frame mold, is not subjected to irregular shape processing simultaneously with the CF substrate 11, the TFT substrate 12, the polarizing plate 51, and the polarizing plate 52.

As described above, according to a production method in accordance with an embodiment of the present invention, the polarizing plates 51 and 52 before subjected to irregular shape processing are bonded to the separate glass substrate before subjected to irregular shape processing, and thereafter, the separate glass substrate 2 and the polarizing plates 51 and 52 are simultaneously subjected to irregular shape processing with use of an end mill or a laser. Thus, it is possible to reduce the steps for the irregular shape processing process by one step, in comparison with the conventional technique of individually subjecting the separate glass substrate 2 and the polarizing plates 51 and 52 to irregular shape processing. This eliminates the maker of the polarizing plates 51 and 52 having to make a capital investment for irregular shape processing of the polarizing plates 51 and 52. Furthermore, it is possible to reduce the time for producing the polarizing plates 51 and 52. This consequently achieves reduction in cost of the polarizing plates 51 and 52 and securement of the capacity.

Moreover, by simultaneously subjecting the separate glass substrate 2 and the polarizing plates 51 and 52 to irregular shape processing with use of an end mill or a laser, it is possible to make the end faces of the polarizing plates 51 and 52, the end face of the CF substrate 11, and the end face of the TFT substrate 12 flush with one another in the produced display panel 3.

(Other Example Production Method)

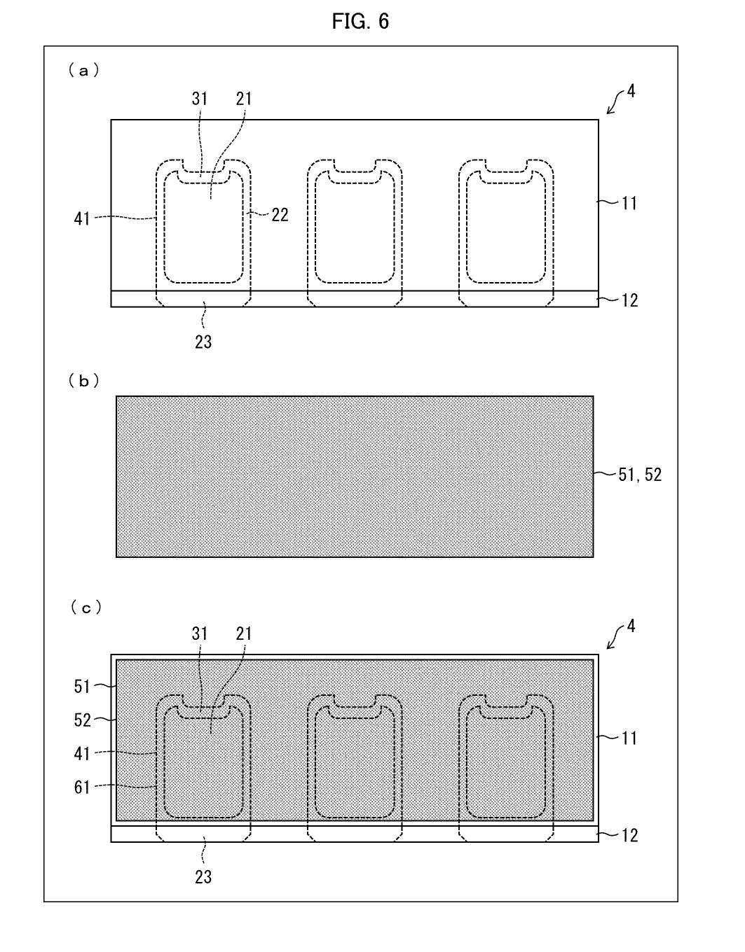

FIG. 6 is an explanatory view illustrating other example method for producing a display panel in accordance with an embodiment of the present invention. In carrying out the production method illustrated in FIG. 6, the display panel maker first prepares a large-sized glass substrate 1, as illustrated in FIG. 1, including a plurality of display regions 21 having respective ones of cutouts 31. Subsequently, as illustrated in (a) of FIG. 6, the display panel maker divides the large-sized glass substrate 1 into medium-sized glass substrates 4 each including display regions which are fewer than the display regions of the large-sized glass substrate 1 and have respective ones of cutouts 31. In (a) of FIG. 6, the large-sized glass substrate 1 is divided into medium-sized glass substrates 4 each including three display regions 21 which have respective ones of the cutouts 31. At this stage, the display panel maker does not subject the medium-sized glass substrate 4 to irregular shape processing.

The maker of the polarizing plates 51 and 52 first produces one or more large-sized polarizing plates. Thereafter, as illustrated in (b) of FIG. 6, the maker of the polarizing plates 51 and 52 divides the one or more large-sized polarizing plates into rectangular polarizing plates 51 and 52 having a size that accommodates the size of the separate medium-sized glass substrates 4 illustrated in (a) of FIG. 6. The maker of the polarizing plates 51 and 52 delivers, to the display panel maker, the polarizing plates 51 and 52 after the division, without subjecting them to irregular shape processing. Alternatively, the maker of the polarizing plates 51 and 52 can deliver one or more large-sized polarizing plates to the display panel maker, and the display panel maker can divide the one or more large-sized polarizing plates thus delivered into the polarizing plates 51 and 52 of a size illustrated in (b) of FIG. 6.

(Bonding of Polarizing Plates 51 and 52)

The display panel maker bonds the rectangular polarizing plate 51 illustrated in (b) of FIG. 6 to the surface of the rectangular medium-sized glass substrate 4 illustrated in (a) of FIG. 6 on the CF substrate 11 side. The polarizing plate 51 is disposed on the surface of the CF substrate 11 in such a manner that three display regions 21 are overlaid in whole with the polarizing plate 51. The display panel maker further bonds the rectangular polarizing plate 52 illustrated in (b) of FIG. 6 to the surface of the TFT substrate 12 in the rectangular separate glass substrate 2 illustrated in (a) of FIG. 6. The polarizing plate 52 is disposed on the surface of the TFT substrate 12 in such a manner that the three display regions 21 are overlaid in whole with the polarizing plate 52. This produces a medium-sized glass substrate 4, as illustrated in (c) of FIG. 6, including three display regions 21 with cutouts 31 and having the polarizing plates 51 and 52 bonded thereto.

The display panel maker does not subject the medium-sized glass substrate 4 illustrated in (c) of FIG. 6 to rectangular shape division into three separate glass substrates 2 in cell units. Instead, the display panel maker performs irregular shape processing simultaneously on the constituent components of the medium-sized glass substrate 4 illustrated in (c) of FIG. 6, i.e., the CF substrate 11, the TFT substrate 12, the polarizing plate 51, and the polarizing plate 52. Specifically, contours 41 of the CF substrate 11 and the TFT substrate 12 and contours 61 of the polarizing plates 51 and 52 are simultaneously cut with use of an end mill or a laser. The display panel maker applies such simultaneous cutting to the contours 41 and the contours 61 at three different positions. This produces, from the medium-sized glass substrate 4, three display panels 3, as illustrated in FIG. 5, each having a narrow frame and having an irregular shape.

In the example case illustrated in FIG. 6, a display panel 3 having a narrow frame and having an irregular shape is obtained as in the example cases illustrated in FIGS. 1 to 5. Furthermore, the example case illustrated in FIG. 6 achieves reduction in effort required to perform bonding of the polarizing plates 51 and 52, in comparison with the case where the polarizing plates 51 and 52 are bonded to an individual separate glass substrate 2 in cell unit.

(Advantages of Display Panel 3)

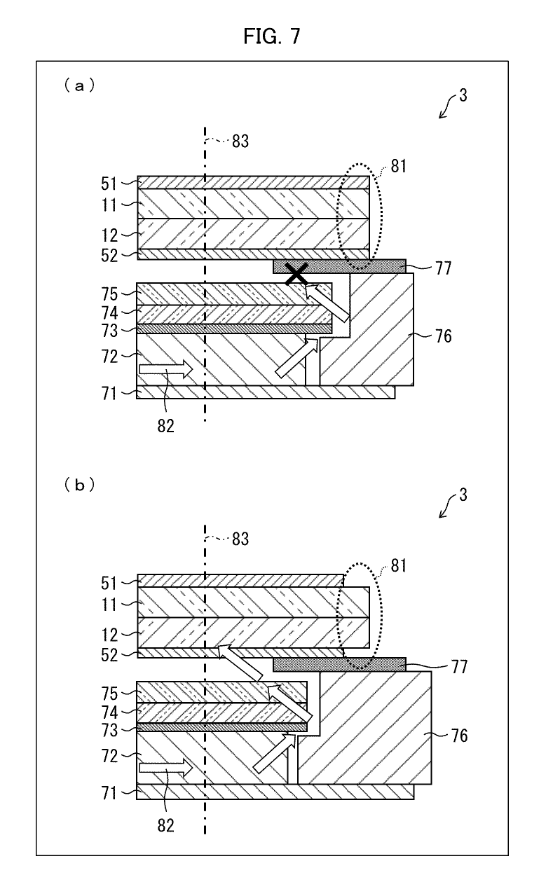

FIG. 7 is an explanatory view illustrating the advantages of the display panel 3 produced by the production method in accordance with an embodiment of the present invention. (a) of FIG. 7 illustrates a cross section of the display panel 3 produced by the production method in accordance with an embodiment of the present invention. (b) of FIG. 7 illustrates a cross section of a display panel 3 produced by the conventional production method. In an example case illustrated in FIG. 7, the display panel 3 is a liquid crystal display panel. The display panel 3 includes a reflecting sheet 71, a light guide plate 72, a diffusing sheet 73, an upper lens sheet 74, a lower lens sheet 75, a plastic frame 76, a double-sided tape 77, a polarizing plate 52, a TFT substrate 12, a CF substrate 11, and a polarizing plate 52. The reflecting sheet 71, the light guide plate 72, the diffusing sheet 73, the upper lens sheet 74, the lower lens sheet 75, and the plastic frame 76 constitutes a backlight module. The polarizing plate 52 and the plastic frame 76 are adhered to each other with the double-sided tape 77.

The cross section illustrated in (a) of FIG. 7 contains the cross section when viewed along the line A-A′ in FIG. 5. In (a) of FIG. 7, all of the respective end portions of the polarizing plate 52, the TFT substrate 12, the CF substrate 11, and the polarizing plate 51 are located identically at the position 81. This allows an area where the polarizing plate 52, the double-sided tape 77, and the plastic frame 76 are close to one another in the display panel 3 to be kept away from a boundary 83 of the display region 21. This allows the inner wall of the plastic frame 76 to be kept away from the boundary 83 of an active region. Thus, light 73 having traveled through the light guide plate 72 and having been reflected by the inner wall of the plastic frame 76 is blocked by a hood-like portion of the double-sided tape 77. Consequently, it is possible to prevent the light 73 from leaking to the display region 21.

The display panel 3 illustrated in (b) of FIG. 7 is produced by a production method according to the conventional technique. The following will gives a brief explanation of the procedure of the production method. The maker of the display panel 3 performs irregular shape processing on the separate glass substrate 2 including the TFT substrate 12 and the CF substrate 11. The maker of the polarizing plates 51 and 52 performs irregular shape processing on each of the polarizing plates 51 and 52 individually. The maker of the display panel 3 bonds the polarizing plate 51 having undergone irregular shape processing to the CF substrate 11 and bonds the polarizing plate 52 having undergone irregular shape processing to the TFT substrate 12.

In (b) of FIG. 7, the respective ends of the TFT substrate 12 and the CF substrate 11 and the respective ends of the polarizing plates 51 and 52 are not located identically at the position 81 and are displaced individually from the position 81. Thus, the inner wall of the plastic frame 76 cannot be kept away from the boundary 83 of the active region. This does not allow light 73 having traveled through the light guide plate 72 and having been reflected by the inner wall of the plastic frame 76 to be blocked by the hood-like portion of the double-sided tape 77. This may leak the light 73 from outside the double-sided tape 77 toward the display region 21.

The display panel produced in accordance with an embodiment of the present invention is not limited to a liquid crystal display panel and can be other kinds of display panels.

[Recap]

First aspect: A method for producing a display panel, including the steps of: bonding a polarizing plate having a rectangular shape to a separate glass substrate, the separate glass substrate having a rectangular shape and including a display region having at least one cutout; and simultaneously cutting a contour of the separate glass substrate and a contour of the polarizing plate with use of an end mill or a laser.

Second aspect: The method according to the first aspect, wherein the display region comprises a plurality of display regions, the method further including the step of: dividing a glass substrate including the plurality of display regions each having the at least one cutout into separate glass substrates, the separate glass substrates each having a rectangular shape and each including a respective one of the plurality of display regions, in the bonding step, bonding the polarizing plate to each of the separate glass substrates into which the glass substrate has been divided.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Large-sized glass substrate
2: Separate glass substrate
3: Display panel
4: Medium-sized glass substrate
11: CF substrate
12: TFT substrate
21: Display region
22: Frame region
23: Connection region
31: Cutout
41: Contour
51: Polarizing plate
52: Polarizing plate
61: Contour

1. A method for producing a display panel, comprising the steps of:
bonding a polarizing plate having a rectangular shape to a separate glass substrate, the separate glass substrate having a rectangular shape and including a display region having at least one cutout; and
simultaneously cutting a contour of the separate glass substrate and a contour of the polarizing plate with use of an end mill or a laser.

2. The method according to claim 1, wherein the display region comprises a plurality of display regions,
said method further comprising the step of:
dividing a glass substrate including the plurality of display regions each having the at least one cutout into separate glass substrates, the separate glass substrates each having a rectangular shape and each including a respective one of the plurality of display regions,
in the bonding step, bonding the polarizing plate to each of the separate glass substrates into which the glass substrate has been divided.
